(19) United States
(12) Patent Application Publication
(10) Pub. No.: US 2025/0361068 A1
(43) Pub. Date: Nov. 27, 2025

(54) Storage Devices for Modular Unit

(71) Applicant: Milwaukee Electric Tool Corporation, Brookfield, WI (US)

(72) Inventors: Aaron M. Williams, Milwaukee, WI (US); Benjamin T. Jones, St. Francis, WI (US); Christian R. Braun, Milwaukee, WI (US); Anna E. Newton, Milwaukee, WI (US)

(21) Appl. No.: 19/174,222

(22) Filed: Apr. 9, 2025

Related U.S. Application Data
(60) Provisional application No. 63/650,018, filed on May 21, 2024.

(51) Int. Cl. B65D 51/28; B25H 3/02; B65D 21/02; B65D 43/16

(52) U.S. Cl. CPC B65D 51/28; B25H 3/021; B65D 21/0222; B65D 43/163

(57) ABSTRACT

Various storage devices that can be utilized with a modular storage system are provided. A modular storage unit includes a base and a lid. In various embodiments, a lid storage system is coupled to an interior surface of the lid. In specific embodiments, the lid storage system includes a mounting plate configured to support various tools and accessories. In various embodiments, a base storage system is coupled to an interior of the base. In various embodiments, a portable storage device is couplable to an exterior surface of the lid and sized such that the portable storage device can be stored within the base.

### CROSS-REFERENCE TO RELATED PATENT APPLICATION

The present application claims the benefit of and priority to U.S. Provisional Application No. 63/650,018, filed on May 21, 2024, which is incorporated herein by reference in its entirety.

### BACKGROUND OF THE INVENTION

The present invention relates generally to the field of containers and related devices. The present disclosure relates specifically to storage devices (e.g., portable storage devices, storage cartridges, lid organizers, etc.) configured to be utilized with utility modules (e.g., units) within a modular system.

Tool storage units are often used to transport tools and tool accessories of various sizes. Various storage structures can be configured to couple externally to units and/or internally within a modular system making tools and tool accessories accessible in a working environment with the tools and/or tool accessories storable within the units for storage and transport.

### SUMMARY OF THE INVENTION

One embodiment of the invention relates to a portable storage device. The portable storage device includes a first storage section with a first side wall having a first height and a second side wall opposing the first side wall. The second side wall has a second height. A first storage compartment is defined between the first side wall and the second side wall. The first height is greater than the second height. The portable storage device includes a second storage section coupled to the first storage section. The second storage section includes a third side wall having a third height and a fourth side wall having a fourth height. The second storage section has a second storage compartment defined between the third side wall and the fourth side wall. The third height is greater than the four height. The portable storage device further includes one or more couplers extending from a lower surface. Where the portable storage device is movable between a first position in which the first storage section and the second storage section are closed, a second position in which the first storage section the second storage section are open, and a third position in which first storage section and the second storage section have a linear orientation.

Another embodiment of the invention relates to a utility module. The utility module includes a base defining a storage compartment and a lid coupled to the base. The lid includes an exterior surface, one or more couplers defined in the exterior surface, and an opposing interior surface. The interior surface includes a plurality of ribs and one or more recessed sections defined between adjacent ribs of the plurality of ribs. The utility module includes a mounting plate couple to the interior surface of the lid. The mounting plate includes a plurality of mounting holes extending through the mounting plate. The mounting plate is configured to support tools or accessories along the lid.

Another embodiment of the invention relates to a utility module. The utility module includes a base having an interior surface that defines a storage compartment and a lid coupled to the base. The lid includes an exterior surface and one or more couplers defined in the exterior surface. The utility module includes a cubby positioned within the storage compartment and along a side of the interior surface of the base. The cubby defines a second storage compartment configured to receive and support tools. The utility module further includes one or more cartridges positioned within the storage compartment and coupled to the base. The one or more cartridges are configured to interlock with other cartridges and the one or more cartridges each include an opening configured to receive and support a tool.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1A is a perspective view of a utility module, according to an exemplary embodiment.

FIG. 1B is a perspective view of the utility module of FIG. 1 engaged with a plurality of other utility modules in a stack, according to an exemplary embodiment.

FIG. 1C is a bottom perspective view of a utility module, according to an exemplary embodiment.

FIG. 2 is a perspective view of the utility module of FIG. 1 with a lid open, according to an exemplary embodiment.

FIG. 3 is a perspective view of a utility module with a lid storage system, according to another exemplary embodiment.

FIG. 4 is a front perspective view of a mounting plate for a utility module, according to an exemplary embodiment.

FIG. 5 is a right side perspective view of the mounting plate of FIG. 4, according to an exemplary embodiment.

FIG. 6 is a perspective view of a utility module with a lid storage system, according to another exemplary embodiment.

FIG. 7 is a front perspective view of the lid storage system of FIG. 6 with storage cases removed, according to another exemplary embodiment.

FIG. 8 is a perspective view from above of the lid storage system of FIG. 7, according to an exemplary embodiment.

FIG. 9 is a perspective view of a storage case holder,, according to an exemplary embodiment.

FIG. 10 is a perspective view of a storage case holder,, according to another exemplary embodiment.

FIG. 11 is a perspective view of a utility module with a lid storage system, according to another exemplary embodiment.

FIG. 12 is a perspective view of the lid storage system of FIG. 11 with storage devices, according to an exemplary embodiment.

FIG. 13 is a perspective view of the lid storage system of FIG. 11 with storage devices, according to another exemplary embodiment.

FIG. 14 is a detailed perspective view of the lid storage system of FIG. 11 with storage devices, according to an exemplary embodiment.

FIG. 15 is a plan view of a storage pouch, according to an exemplary embodiment

FIG. 16 is a mount for the storage pouch of FIG. 15, according to an exemplary embodiment.

FIG. 17 is a plan view of a small storage pouch, according to an exemplary embodiment.

FIG. 18 is a plan view of the small storage pouch of FIG. 17, according to an exemplary embodiment.

FIG. 19 is a perspective view of a lid storage system, according to another exemplary embodiment.

FIG. 20 is a detailed perspective view of the lid storage system of FIG. 19, according to an exemplary embodiment.

FIG. 21 is a detailed perspective view of the lid storage system of FIG. 19, according to an exemplary embodiment.

FIG. 22 is a perspective view of a utility module with a lid storage system, according to another exemplary embodiment.

FIG. 23 is a perspective view of a utility module with a lid storage system, according to another exemplary embodiment.

FIG. 24 is a perspective view of a utility module with a lid storage system, according to another exemplary embodiment.

FIG. 25 is a perspective view of a utility module with a lid storage system, according to another exemplary embodiment.

FIG. 26 is a perspective view of a utility module with a lid storage system, according to another exemplary embodiment.

FIG. 27 is a perspective view of a utility module with a base storage system, according to an exemplary embodiment.

FIG. 28 is a perspective view of a utility module with a base storage system, according to another exemplary embodiment.

FIG. 29 is a perspective view of a utility module with a base storage system, according to another exemplary embodiment.

FIG. 30 is a cubby of the base storage system, according to an exemplary embodiment.

FIG. 31 is a wall panel of the base storage system, according to an exemplary embodiment.

FIG. 32 is a perspective view of cubbies and wall panels, according to an exemplary embodiment.

FIG. 33 is a perspective view of a storage cartridge, according to an exemplary embodiment.

FIG. 34 is partially exploded view of a storage cartridge, according to another exemplary embodiment.

FIG. 35 is a perspective view of a cubby and storage cartridges, according to another exemplary embodiment.

FIG. 36 is a perspective view of a cubby and storage cartridges, according to another exemplary embodiment.

FIG. 37 is a perspective view of a utility module with a portable storage system, according to an exemplary embodiment.

FIG. 38 is a perspective view of the utility module of FIG. 37 coupled to the portable storage system.

FIG. 39 is a perspective view of a portable storage system in a first position, according to an exemplary embodiment.

FIG. 40 is a perspective view of the portable storage system of FIG. 39 in a second position, according to an exemplary embodiment.

FIG. 41 is a perspective view of the portable storage system of FIG. 39 in a third position, according to an exemplary embodiment.

FIG. 42 is a perspective view of the portable storage system of FIG. 41 coupled to a cart, according to an exemplary embodiment.

FIG. 43 is a plan view from the outside of the portable storage system in a closed position, according to an exemplary embodiment.

FIG. 44 is a plan view from the inside of the portable storage system in an open position, according to an exemplary embodiment.

FIG. 45 is a detailed plan view of back pockets of the portable storage system of FIG. 44.

FIG. 46 is a detailed plan view of front pockets of the portable storage system of FIG. 44, according to an exemplary embodiment.

FIG. 47 is a top view of the pockets of the portable storage system, according to an exemplary embodiment.

FIG. 48 is a perspective view of the portable storage system in the first position, with the fabric removed, according to an exemplary embodiment.

FIG. 49 is a perspective view of the portable storage system in the second position, with the fabric removed, according to an exemplary embodiment.

FIG. 50 is a perspective view of the portable storage system in the third position, with the fabric removed, according to an exemplary embodiment.

### DETAILED DESCRIPTION

Referring generally to the figures, various embodiments of storage and/or organization systems for use with a modular system are shown according to exemplary embodiments. The storage and/or organization systems are configured to couple externally and/or internally to units or modules within the modular system making tools and tool accessories available in a working environment (i.e., easy, efficient to grab) with the tools and/or tool accessories storable within the units for transport and safety (i.e., avoidance of theft).

As will be generally understood, within individual storage units and modules, organization of tools and/or tool accessories of various sizes is difficult because conventional solutions (e.g., storage trays, separate compartments) do not fit with large tools, such as large power tools in addition to small tools or accessories in an organized, accessible manner. Applicant believes use of the storage and/or organization systems discussed herein allows for storing large power tools, small hand tools, accessories, storage cases, etc., securely all within a single modular unit without extensive digging or searching for the desired tool and/or accessory.

In various embodiments, the utility module includes a lid storage system coupled to an interior surface of the lid. In various specific embodiments, the lid storage system includes a base or mounting plate coupled to the lid. The mounting plate includes a plurality of mounting locations to allow for compatibility with various types of storage systems and customization by individual users. For example, storage systems such as fabric pouches, hard cases, magnets, etc. can all be attached to the mounting plate simultaneously. Applicant believes such lid storage systems allow for storing small and fragile items in an easily accessible location, without interfering with the capacity of the utility module. In other words, the low profile of the lid storage system allows for organization and quick access to small tools, tool accessories, fragile items, etc. without blocking access to larger tools stored within the base of the utility module.

In various embodiments, the lid storage system includes one or more bit storage trays. In such embodiments, one or more bit storage trays are removably couplable to the lid of the utility module. In various specific embodiments, the bit storage tray(s) are friction fit into ribs of the lid allowing for easy removal of the bit storage tray(s). In various specific embodiments, the bit storage tray(s) include finger tabs or recesses to allow a user to grasp and quickly remove the bit storage tray(s). Applicant believes such lid storage systems allow for fast retrieval of frequently used bits. In various other embodiments, the lid storage system includes soft sided storage devices (e.g., fabric storage containers, pouches, etc.) to securely retain tools and/or tool accessories in position against the lid.

In various embodiments, the utility module includes a base storage system coupled to and/or positioned within the base compartment or cavity of the utility module. In various embodiments, the base storage system includes a cubby, wall panels, and/or a universal cartridges. Applicant believes such storage systems allow for organization of tools and tool accessories of various shapes and sizes while improving worker efficiency (e.g., can quickly grab) and maintaining storage density. For example, the cubby allows for storage of larger tools and accessories (e.g., power tools, volt meters, hard storage cases, etc.) while smaller tools, such as hand tools are storable in cartridges in generally vertical orientations such that the size and/or tool type is easily visible to a user.

In various embodiments, the utility module includes a portable storage system and/or a portable storage device, such as a portable storage tote. In various specific embodiments, the portable storage device is configured to couple externally to units and/or internally within a modular system making tools and tool accessories accessible in a working environment with the tools and/or tool accessories storable within the units for storage and transport. For example, the portable storage device may include one or more male couplers to allow for coupling to the upper surface of the utility module and also be sized to fit easily within a section of the utility module base (e.g., half of base, etc.).

In various specific embodiments, the portable tool storage device is transformable or foldable into various positions to allow for easy access in multiple working environments. In a specific embodiment, the portable storage device is foldable into three positions. In such an embodiment, the storage device is foldable into a first position in which the tools and/or tool accessories are enclosed or positioned between sides of the storage device (i.e., a closed tote). In a second position, the storage device is folded in an opposite orientation from the first orientation such that sides of the storage device are open (i.e., an open tote). In a third position, the storage device has a linear or flat orientation such that the storage device can be hung along the side of a lift, cart, wall, etc. Applicant believes the multiple configurations of the portable storage device allow for dense tool storage appropriate for various working environments and storage arrangements.

In various embodiments, the utility module may include one or more female couplers extend from and/or located in the upper surface of the utility module, that are configured to engage one or more male couplers of an adjacent modular storage unit. In various embodiments, the male and female couplers described herein and shown in the figures are compatible with the coupling mechanism(s) described in International Patent International Patent Publication No. WO 2017/191628, which is hereby incorporated by reference in its entirety. In various embodiments, the female couplers and male couplers described herein engage with each other to rigidly couple the utility modules that the female couplers and male couplers extend from.

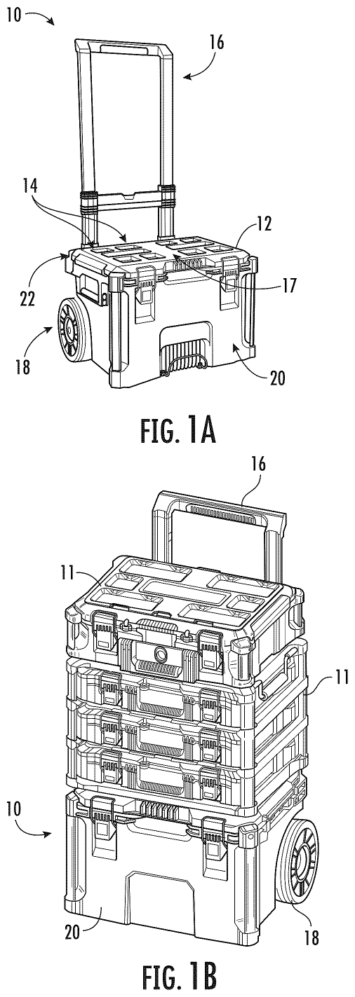

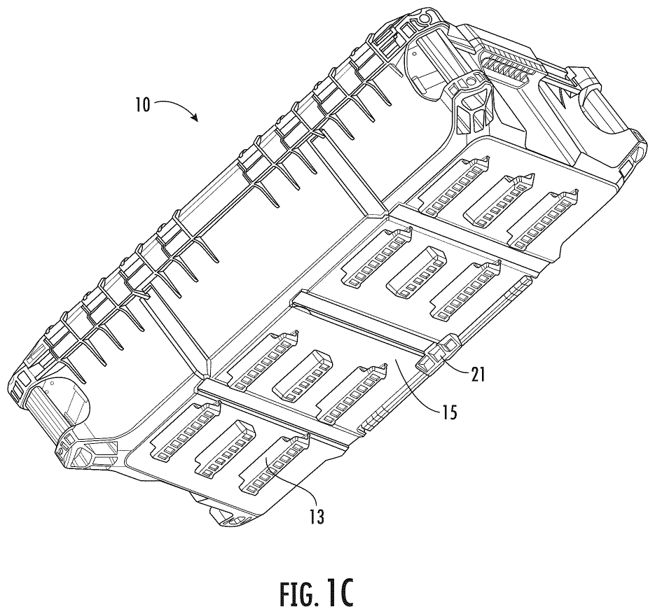

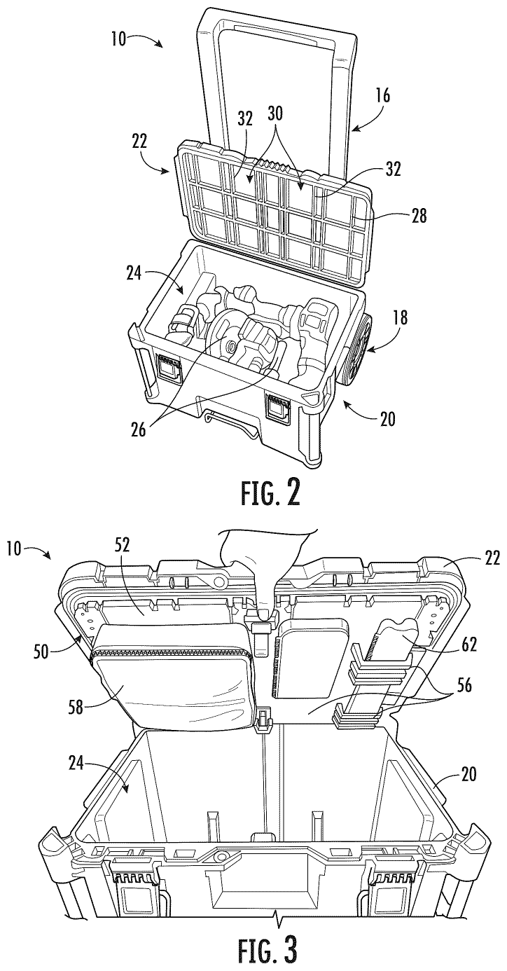

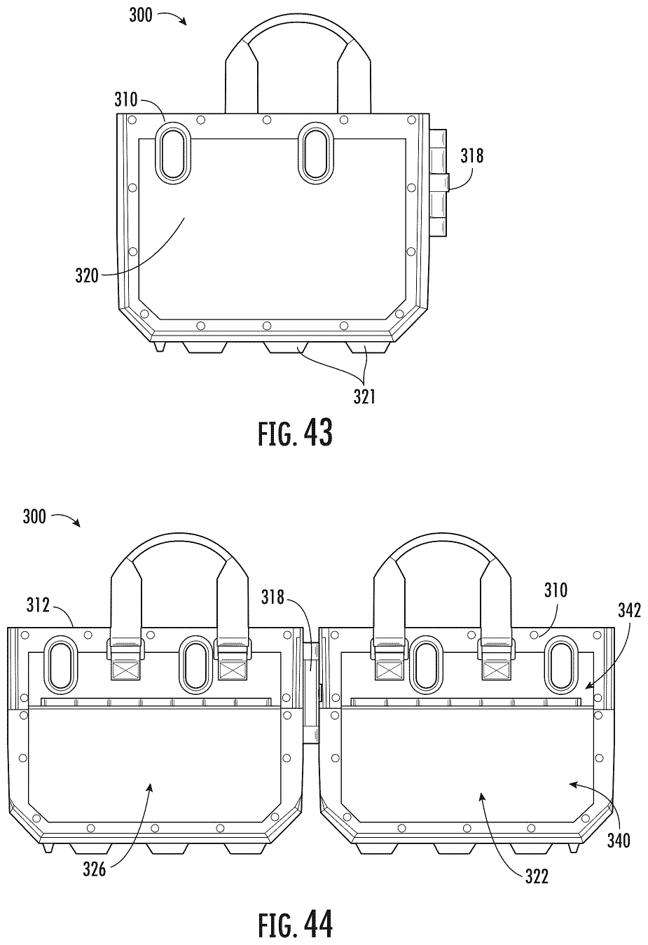

Referring to FIGS. 1A-2, various aspects of a utility module 10 are shown according to an exemplary embodiment. Utility module 10 includes a main body or base 20 that defines a storage compartment or cavity 24 and a lid 22. In specific embodiments, lid 22 is rotatably coupled to base 20. Lid 22 includes an upper, outward facing surface 12 and an opposing interior (i.e. inward facing) surface 28 facing away from the upper surface 12. Interior surface 28 includes one or more recessed sections 30 defined between ribs 32. One or more female couplers 14 extend from and/or are located in upper surface 12 of utility module 10. The one or more female couplers 14 are configured to engage one or more male couplers (see e.g., male couplers 13 in FIG. 1C and 321 in FIG. 43) that extend from a surface such as a lower and/or rear surface of another utility module or storage device.

In specific embodiments, utility module 10 includes a latch recess 17 configured to interface with a latch 21 on another utility module 11 to secure utility module 10 to other objects and/or utility modules. As shown in FIG. 1B, utility modules 11 can be removably engaged with utility module 10. Specifically, male couplers 13 on a bottom surface 15 of utility module 11 are configured to engage with female couplers 14 defined in upper surface 12 of utility module 10 to connect utility module 10 and one or more utility modules 11.

Male coupler 13 includes a body extending from the bottom surface 15, a first tongue or projection, and a second tongue or projection. The first tongue and the second tongue both extend from the body and both are offset from and above the bottom surface 15. The first tongue defines a first channel between the bottom surface 15 and the first tongue, and the second tongue defines a second channel between the bottom surface 15 and the second tongue. The first channel and second channel each extend on opposing sides of the body. Each of first channel and second channel includes a front open end and a back closed end. For example, first channel includes a front open end and a back closed end, and second channel includes a front open end and a back closed end.

In various specific embodiments, a handle 16 is coupled to base 20 along a rear wall. In various embodiments, utility module 10 further includes wheels 18. Wheels 18 are coupled to base 20 adjacent to the rear wall and/or wheels 18. As will be generally understood, utility module 10 can be utilized as part of a storage system. Cavity 24 of base 20 is configured to receive various tools and tool accessories 26.

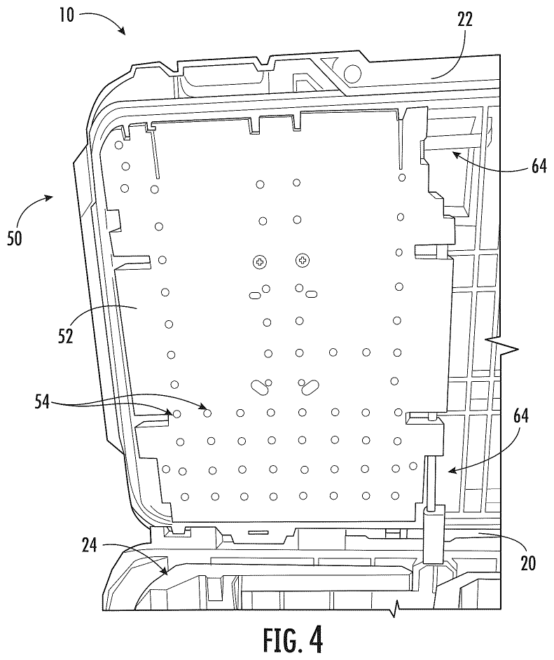

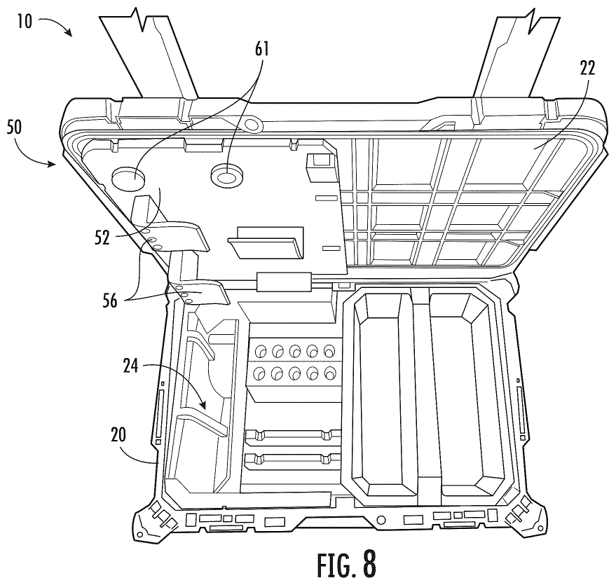

Referring to FIGS. 3-8, various aspects of a lid storage system 50 that can be utilized with storage devices such as utility module 10 are shown according to an exemplary embodiment. As previously noted, Applicant believes such lid storage systems allow for storing small and fragile items in an easily accessible location (along the lid), without interfering with the capacity of the cavity of the utility module. In order to avoid such interference, the lid storage systems discussed herein extend less than a maximum distance from the interior surface of the.

Lid storage system 50 includes one or more mounting plates 52. In various embodiments, the mounting plate 52 is sized to fit one half of the lid 22. In other words, two mounting plates 52 can be coupled to interior surface 28 of lid 22. In such an embodiment, the mounting plate 52 has a first size and the interior of the lid 22 has a second size, where the first size is half of the second size. Each mounting plate 52 includes a plurality of mounting locations, shown as holes 54. In other words, a plurality of mounting holes 54 extend through the mounting plate 52. Holes 54 allow for various accessories and tools 26 to be supported and secure along lid 22. In various embodiments, holes 54 are arranged into an array. In specific embodiments, holes 54 are arranged in columns on mounting plate 52. In specific embodiments, holes 54 are arranged in rows on mounting plate 52. In various specific embodiments, holes 54 are arranged in rows and columns on mounting plate 52. In various specific embodiments, mounting plate 52 is attached to interior surface 28 of lid 22 by fasteners, such as screws that are received within threaded bosses or screw holes positioned along interior surface 28 of lid 22.

In various specific embodiments, lid storage system 50 includes a lid prop 64. Applicant believes use of a lid prop 64 reduces the likelihood of user closing their fingers or another tool or tool accessory 26 in the lid 22 during use of utility module 10. In a specific embodiment, lid prop 64 is position in the middle of lid 22 along the interior side of each mounting plate 52. Lid prop 64 is configured to rotate with respect to lid 22 and mounting plate 52 to allow for engagement with base 20. In various specific embodiments, lid prop 64 is automatically deployed due to gravity. In specific embodiments, a latch 63 at the top of lid 22 and/or mounting plate 52 can be actuated to disengage lid prop 64, allowing a user to close lid 22.

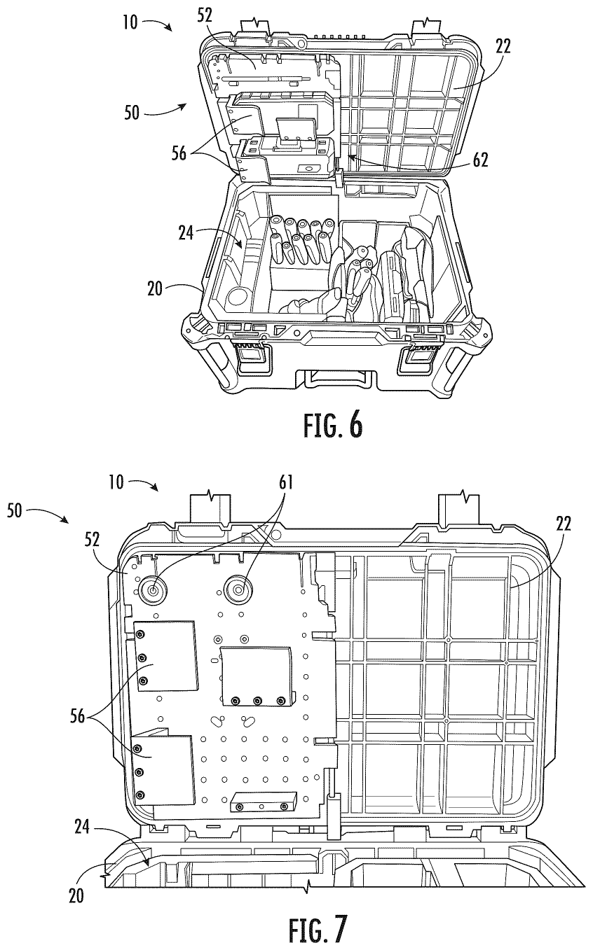

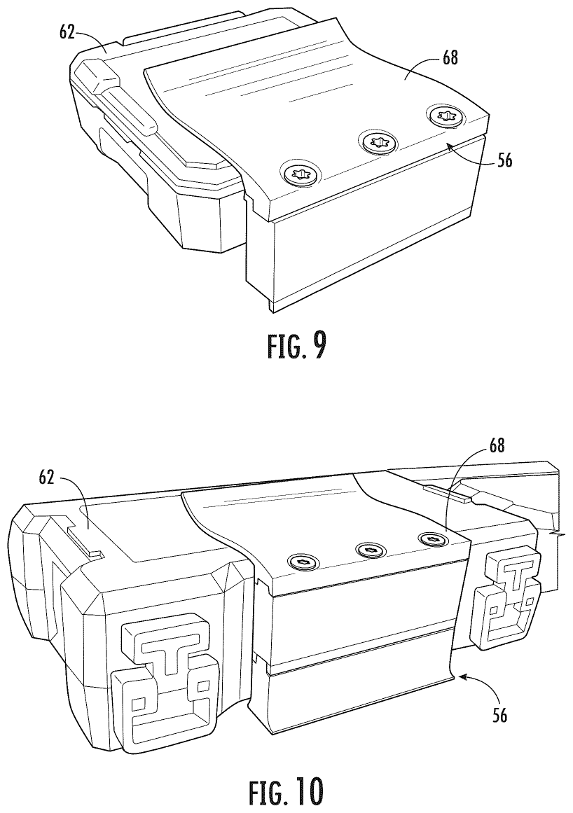

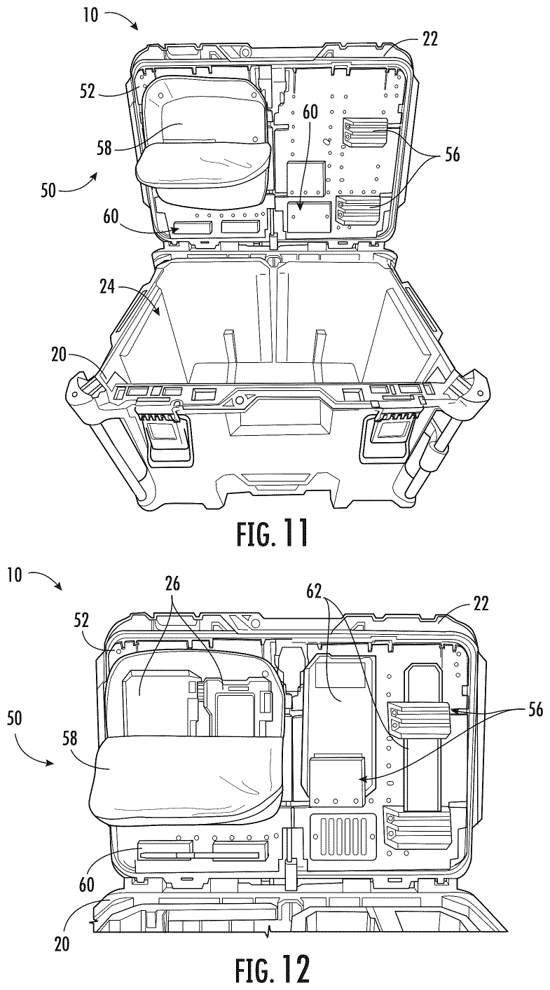

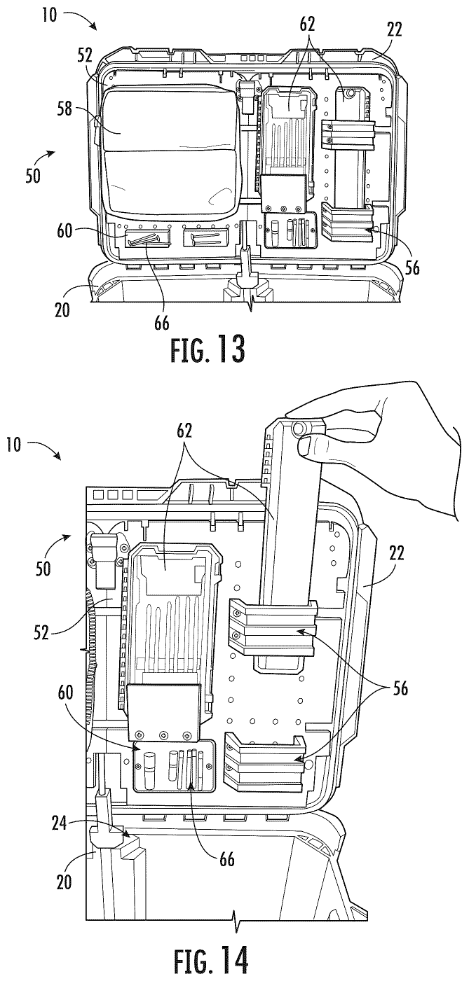

Referring to FIGS. 6-14, various attachment features that can be utilized with mounting plate 52 are shown according to exemplary embodiments. Brackets 56 can be fastened to mounting plate 52. In various specific embodiments, brackets 56 include an arm 68 configured to secure a storage device, such as a hard case 62 along mounting plate 52 and specifically along an interior surface of mounting plate 52. When brackets 56 are in use, the arm 68 extends in front of the hard case 62 such that the hard case 62 is positioned between the bracket 56 and lid 22. In various embodiments, arm 68 extends in a generally parallel (e.g., 180 degrees plus or minus 20 degrees) orientation to mounting plate 52 when bracket 56 is coupled to mounting plate 52.

Brackets 56 have various sizes to accommodate for securing different sizes and/or shapes of hard cases 62. As shown in FIGS. 6-8, brackets 56 can be oriented in various directions, allowing for hard cases 62 to be storage vertically or horizontally along mounting plate 52. In various specific embodiments, multiple brackets 56 can be used to secure hard cases 62 at both ends.

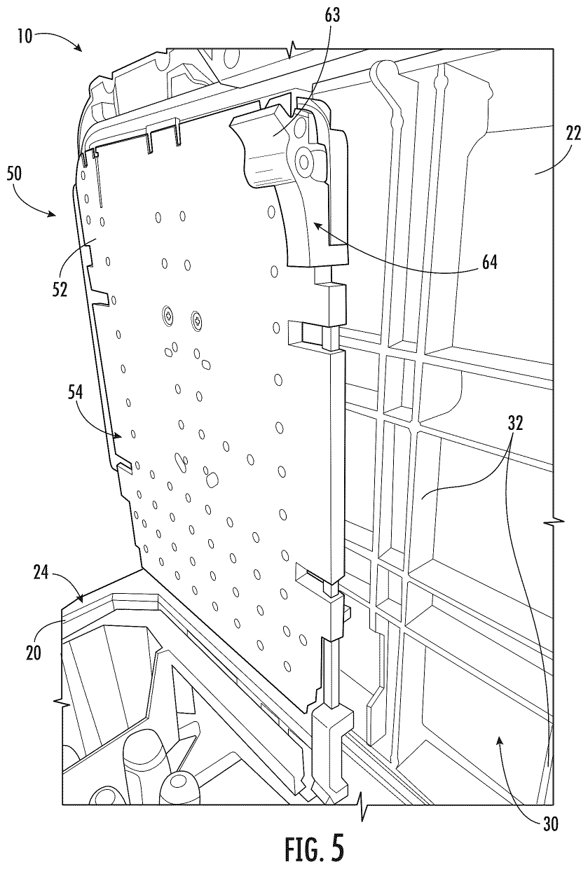

In various embodiments, lid storage system 50 includes magnets 61 and/or magnetic plates 60. As can be seen in FIGS. 5-6, magnets 61 can be coupled to mounting plate 52 to support small accessories such as a marker (see e.g., FIG. 6). Magnetic plate 60 is larger than the magnets 61 and configured to support multiple components along lid 22. In specific embodiments, magnetic plate 60 is configured to secure components 66 such as fasteners, nails, bits etc. for easy access.

In various embodiments, lid storage system 50 includes a soft pouch, shown as large pouch 58. Large pouch 58 is formed from a fabric material and allows for tools and/or tool accessories 26 to be enclosed along lid 22. Applicant believes the large pouch 58 allows for small, fragile components, hand tools, and accessories to be grouped for quick retrieval by the user.

In order for a user to customize a utility module 10, a user first opens the lid 22 of the utility module 10. As a second step, the user couples a mounting plate 52 to interior surface 28 with one or more fasteners. In a specific embodiment, a mounting plate 52 is coupled to each side of interior surface 28 of lid 22. In a third step, the user selects a plurality of different storage devices (e.g., large pouch 58, brackets 56, magnetic plate 60, etc.) and attaches them in chosen mounting holes 52 on mounting plate 52 using one or more fasteners.

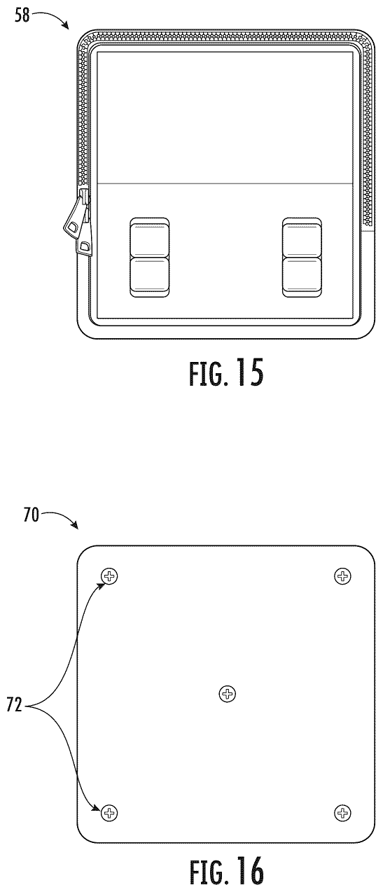

Referring to FIGS. 15-16, various details of large pouch 58 are shown according to an exemplary embodiment. A backing 70 can be used to couple large pouch 58 to mounting plate 52. In various specific embodiments, backing 70 is a hard backing including a plurality of mounting holes 72.

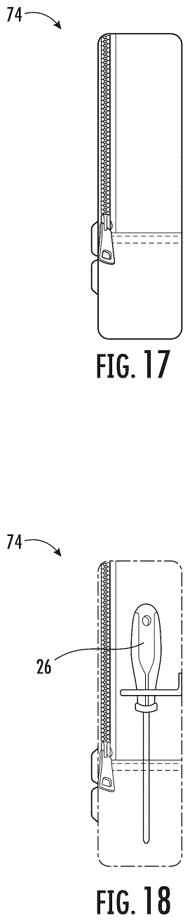

Referring to FIGS. 17-18, various details of a small pouch 74 is shown according to an exemplary embodiment. Small pouch 74 can be utilized with lid storage system 50. Small pouch 74 is configured to hold small accessories and or hand tools 26.

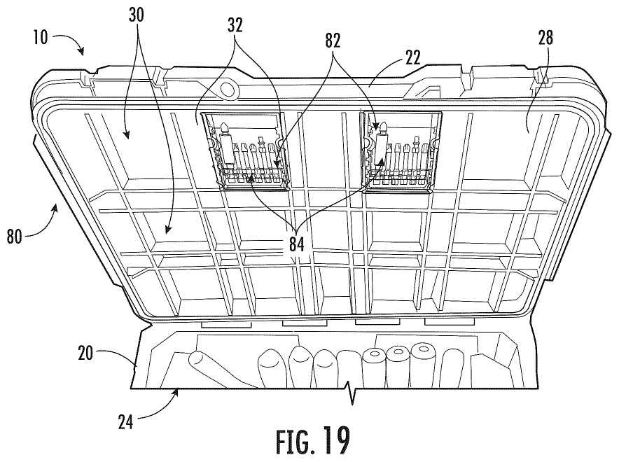

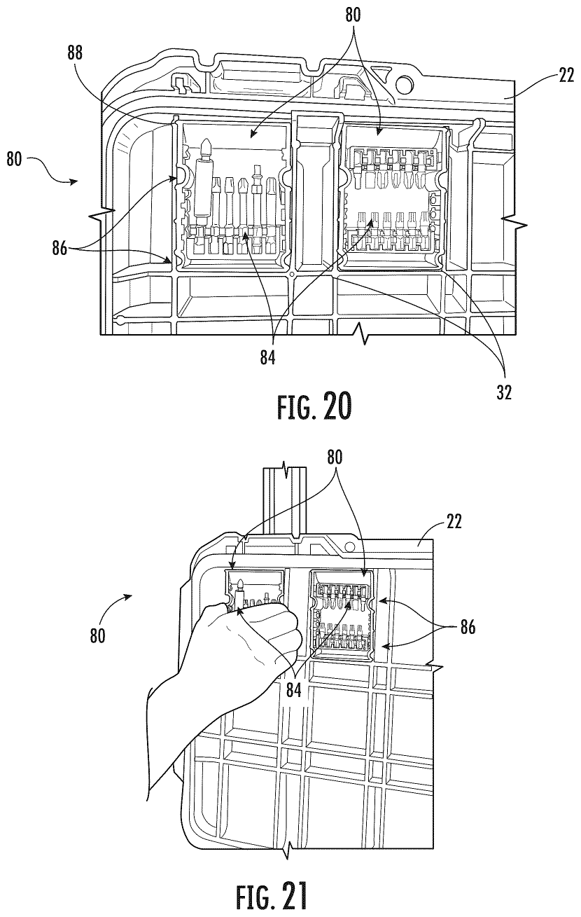

Referring to FIGS. 19-21, various aspects of a lid storage system 80 are shown according to an exemplary embodiment. Lid storage system 80 can be utilized with storage devices such as utility module 10. As will be discussed in greater detail below, lid storage system 80 is configured to support a plurality of bits 84 along lid 22 allowing for easy access to frequently used components. Unlike simple magnets, lid storage system 80 allows for increased organization and storage of bits 84 of various sizes.

In various specific embodiments, lid storage system 80 includes one or more trays 82 configured to be coupled directly to lid 22. Specifically, interior surface 28 of lid 22 includes recessed portions 30 with ribs 32 on opposing sides of recessed portions 30. Trays 82 are sized to be received within recessed portions 30 with the ribs 32 retaining the trays 82 against lid 22. In various specific embodiments, trays 82 are press fit into recessed portions 30 of the lid.

In various specific embodiments, tray 82 includes one or more finger recesses 86 defined in edges 88 of tray 82. Applicant believes finger recesses 86 allow for quick and easy removal of the entire tray 82 from lid 22 (see e.g., FIG. 21). When a user grasps the finger recesses 85 and pulls along edges 88, tray 82 is removable from lid 22.

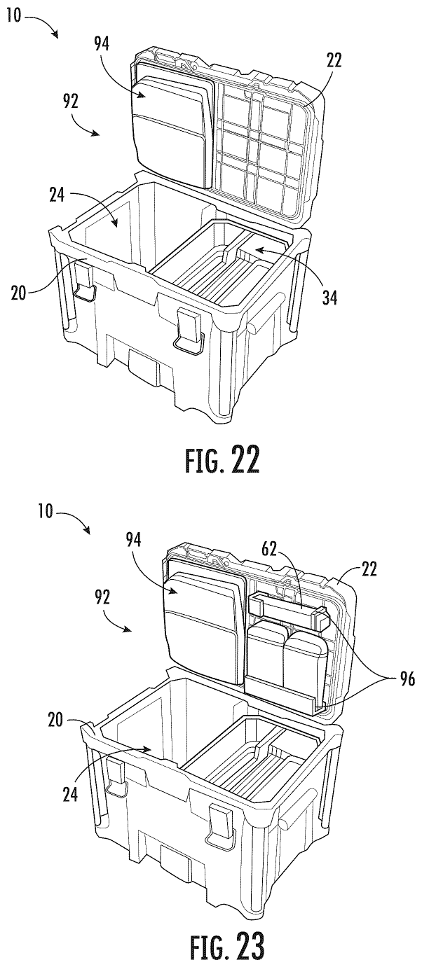

Referring to FIGS. 22-23, various aspects of a lid storage system 92 are shown according to an exemplary embodiment. Lid storage system 92 can be utilized with storage devices such as utility module 10 and coupled to lid 22. Lid storage system 92 includes a soft sided storage device 94 coupled to lid 22. Lid storage system 92 further includes one or more brackets 96 configured to support and retain hard cases 62.

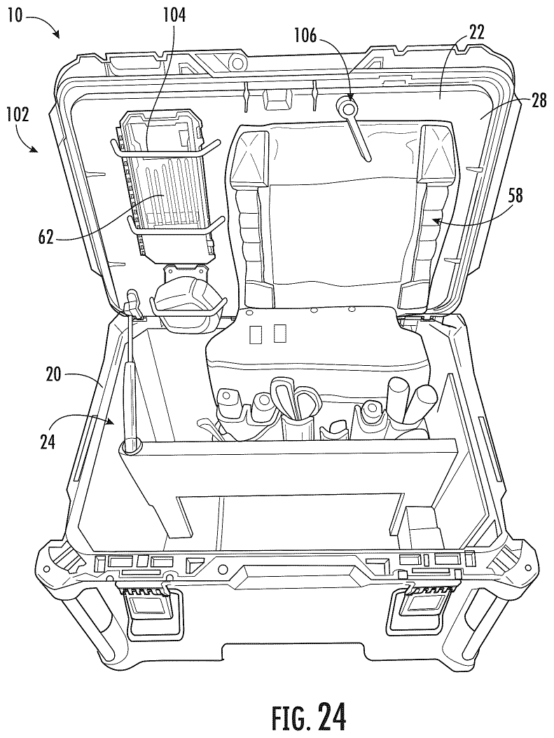

Referring to FIG. 24, various aspects of a lid storage system 102 are shown according to an exemplary embodiment. Lid storage system 102 can be utilized with storage devices such as utility module 10 and coupled to lid 22. Lid storage system 102 includes one or more straps 104 extended from interior surface 28 of lid 22. Hard cases 62 can be secured against interior surface 28 by the one or more straps 104. In various embodiments, lid storage system 102 further includes a retractable connector 106 coupled to a large pouch 58.

Referring to FIG. 25, various aspects of a lid storage system 112 are shown according to an exemplary embodiment. Lid storage system 112 can be utilized with storage devices such as utility module 10 and coupled to lid 22. Lid storage system 112 includes more than one type of mounting plate 114, 115 coupled to interior surface 28 of lid 22. Mounting plate 114 includes a plurality of mounting locations, shown as holes 116. In contrast, mounting plate 115 includes fewer mounting locations than mounting plate 114 and is configured to support brackets 118.

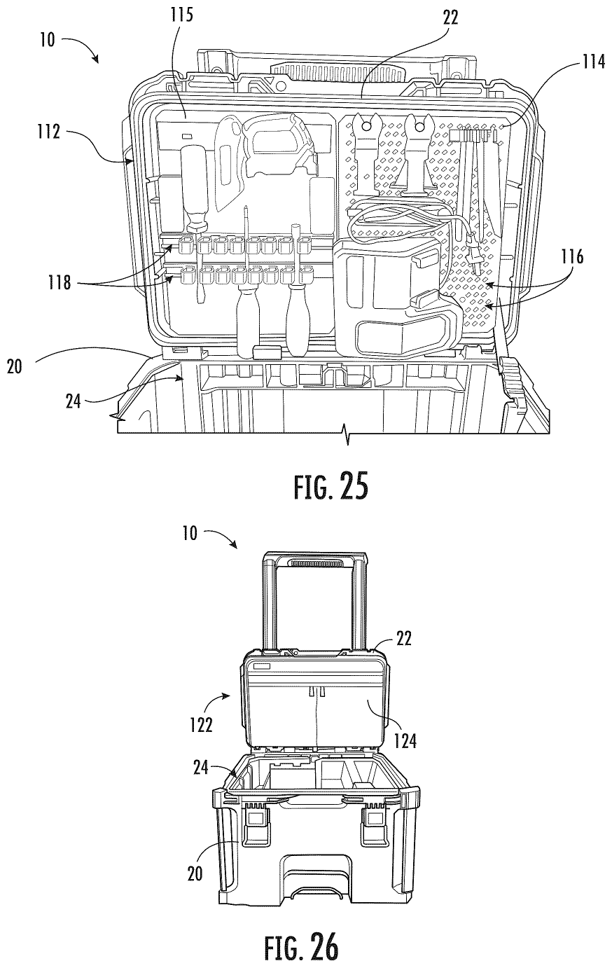

Referring to FIG. 26, various aspects of a lid storage system 122 are shown according to an exemplary embodiment. Lid storage system 122 can be utilized with storage devices such as utility module 10 and coupled to lid 22. Lid storage system 122 includes a soft sided storage device 124. In various specific embodiments, soft sided storage device 124 extends across the entire width of lid 22 and interior surface 28.

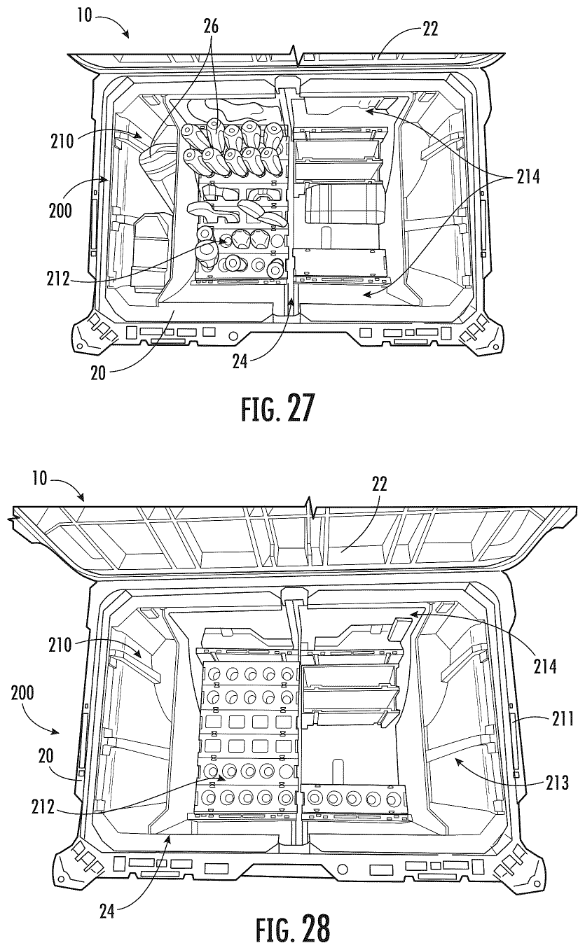

Referring to FIGS. 27-29, various aspects of a base storage system 200 are shown according to an exemplary embodiment. Base storage system 200 can be utilized with storage devices such as utility module 10 and coupled to and/or positioned within base 20. Base storage system 200 can also be utilized with lid storage systems 50, 80, 92, 102, 112, 122 and other storage devices.

In various specific embodiments, the base storage system 200 includes a cubby 210, wall panel(s) 214, and/or a universal cartridge(s) 212. Applicant believes such storage systems allow for organization of tools and tool accessories 26 of various shapes and sizes while improving worker efficiency (e.g., can quickly grab) and maintaining storage density of the utility module 10. For example, the cubby 210 allows for storage of larger tools and accessories 26 (e.g., power tools, volt meters, hard storage cases, etc.) while smaller tools, such as hand tools are storable in cartridges 212 in generally vertical orientations (e.g., extending upward from the bottom of the base) such that the size and/or tool type is easily visible to a user.

As shown in FIGS. 27-28, in various specific embodiments, base storage system 200 includes one or more cubbies 210 positioned along the sides 211 of base 20. Each cubby 210 is sized to allow for storage of larger tools and/or tool accessories (e.g., power tools, batteries, etc.) in utility module 10 along with smaller hand tools and accessories. In various specific embodiments, cubby 210 includes a cavity or compartment 213 sized to receive power tools such as drills, drivers, etc.

In various specific embodiments, base storage system 200 includes one or more cartridges 212 positioned within compartment 24 of base 20. Cartridges 212 are configured to interlock with other cartridges 212, allowing a user to organize tools and accessories in a desired manner. For example, users can choose a desired number of cartridges 212 and interlock the cartridges to create a screwdriver section within utility module 10. As will be discussed in greater detail below, cartridges include various openings or cutouts to allow for storage of different sizes and types of tools.

In various specific embodiments, base storage system 200 includes one or more wall panels 214 positioned within compartment 24 of base 20. Wall panels 214 can be utilized with cubbies 210 and/or cartridges 212. Wall panels 214 are mountable along an interior surface of the walls of base 20.

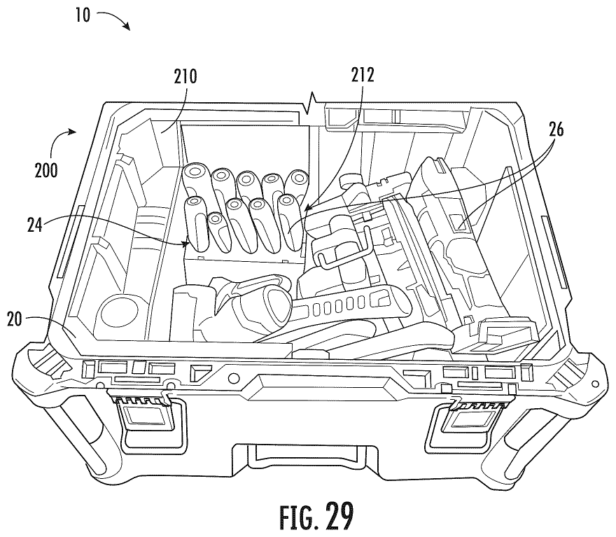

As shown in FIG. 29, in various specific embodiments, a single cubby 210 can be utilized with cartridges 212 in a portion of compartment 24 of base. For example, the cubby 210 and cartridges 212 may provide storage for half of the compartment 24.

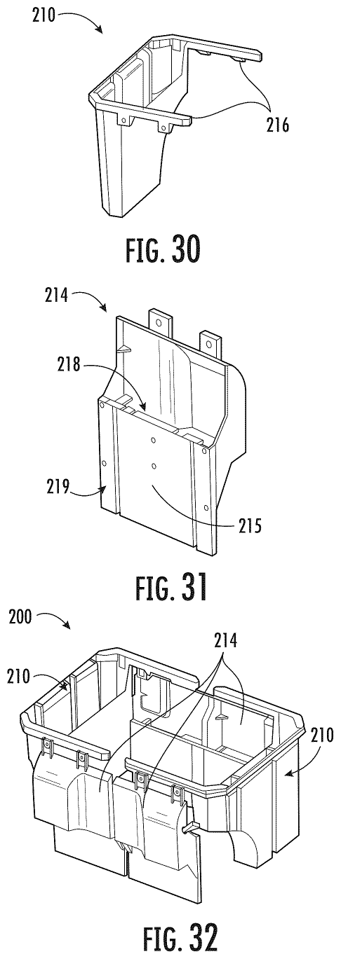

Referring to FIG. 30, details of a cubby 210 are shown according to an exemplary embodiment. Each cubby 210 includes projecting arms 216 to allow for connection with other storage devices. In various specific embodiments, cubby 210 is positioned within an interior undercut in base 20.

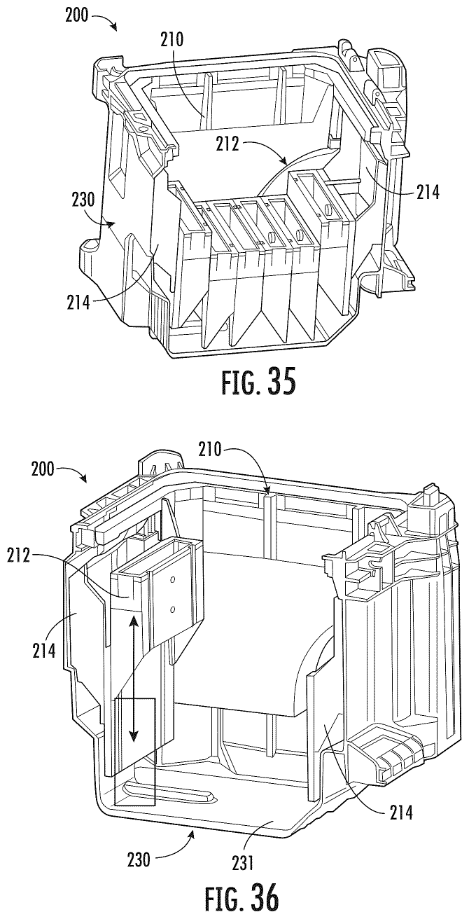

Referring to FIG. 31, details of a wall panel 214 are shown according to an exemplary embodiment. Wall panel 214 includes a compartment 218. As will be discussed in great detail below, a front 215 of wall panel 214 is configured to support and/or couple to other storage devices such as cartridges 212. In such embodiments, wall panel 214 is positioned between base 20 and the cartridge 212 and provides support and stability to the cartridge 212 (see e.g., FIG. 35).

Referring to FIG. 32, various aspects of the connection between cubbies 210 and wall panels 214 are shown according to another exemplary embodiment. In specific embodiments, a cubby 210 may be positioned on either side of the base 20 such that arms 216 extend inward and are connectable to one or more wall panels 214.

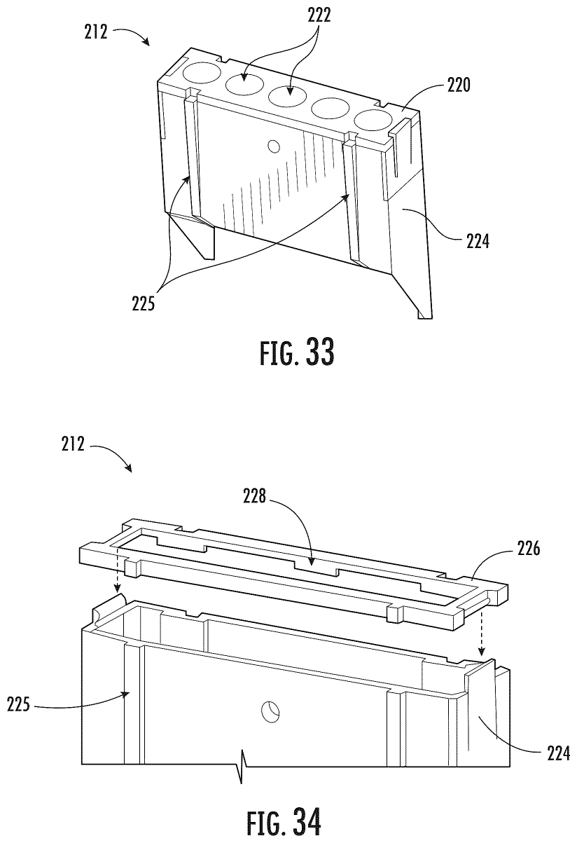

Referring to FIGS. 33-34, details of cartridges 212 are shown according to exemplary embodiments. As shown in FIG. 33, cartridge 212 includes a body 224 shaped to allow for interconnection to various other storage devices including cartridges 212. In specific embodiments, body 224 has a dovetail joint 225.

Cartridge 212 includes a top 220 that can be chosen based on the accessory or tool to be stored. In specific embodiments, top 220 includes a plurality of openings 222. In such embodiments, small and/or narrow tools can be stored in a generally vertical orientation (e.g., end extends upward from cartridge) allowing a user to easily identify and remove a desired tool. In various other embodiments, cartridge 212 includes a top 226 coupled to body 224. Top 226 includes a single, elongate opening 228 to allow for storage of larger and/or elongate tools.

Referring to FIGS. 35-36, various aspects of base storage system 200 are shown according to another exemplary embodiment. As shown in FIG. 35, cartridges 212 can be interlocked with wall panel 214 and other cartridges 212. In such an embodiment, a plurality of cartridges 212 may be coupled to and extend between a pair of wall panels 214 mounted to a base 230 of a utility module.

As shown in FIG. 36, when a user wants to add a cartridge 212 to the base storage system 200, the cartridge body 224 can moved downward (e.g., toward a bottom 231 of base 230) to engage with dovetail joints 219 on wall panel 214. In specific embodiments, the dovetail joints 219, 225 are attached via snap fit. Applicant believes, these types of connections allow for fast and easy customization of a utility module.

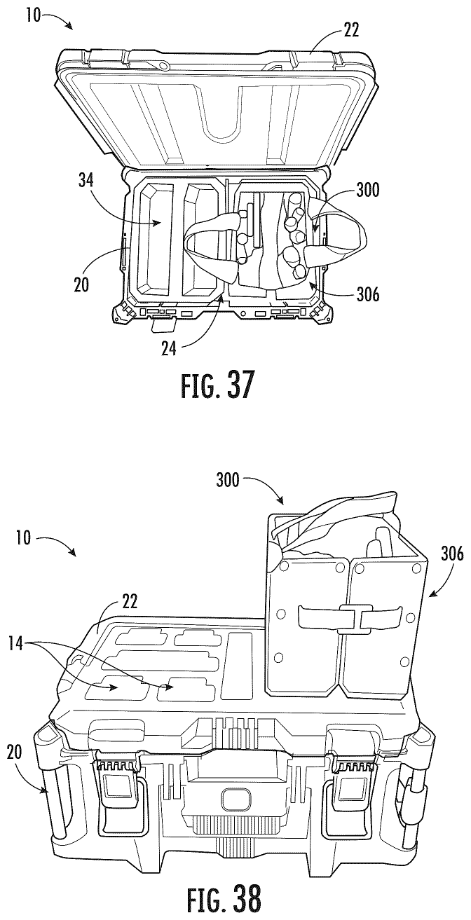

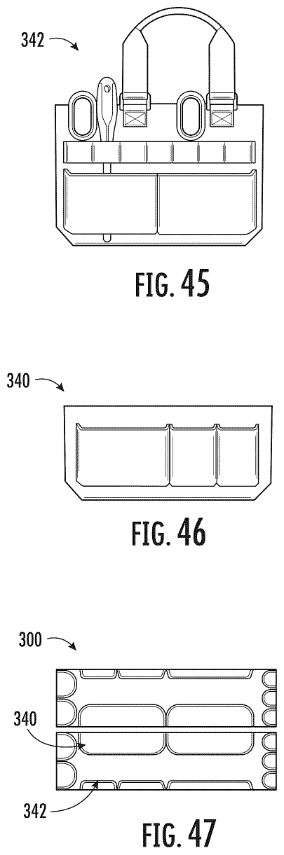

Referring to FIGS. 37-50, various aspects of a portable storage system shown as portable storage system 300 are shown according to exemplary embodiments. In various embodiments, portable storage system 300 includes a portable storage device, such as a portable storage tote 306. In various specific embodiments, the portable storage tote 306 is configured to couple externally to units (see e.g., FIG. 38) and/or internally (see e.g., FIG. 37) within a modular system making tools and tool accessories accessible in a working environment with the tools and/or tool accessories storable within the units for storage and transport.

For example, the portable storage tote 306 may include one or more male couplers (see e.g., male coupler 321 in FIG. 43) to allow for coupling to the upper or exterior surface 12 of the utility module 10 and also be sized to fit easily within a section of the utility module base (e.g., half of base, etc.). Applicant believes the portable storage system 300 allows for tools and tool accessories to be portable while maintaining organization that conventional trays or boxes lack.

In practice, portable storage tote 306 can be utilized with a utility module, such as utility module 10. First, a user must unstack various utility modules 11 that are coupled to the bottom utility module 10. In other words, upper utility modules 11 are removed to open the lower utility module 10. As a second step, the user removes portable storage tote 306 from compartment 24 within base 20 where the portable storage tote 306 is stored. While stored, portable storage tote 306 is in a first folded orientation. In various embodiments, the user can couple portable storage tote 306 and specifically male couplers 321 to the female couplers 14 defined in upper surface 12 of utility module 10. In various other embodiments, a user can move portable storage tote 306 from the first, folded orientation into a second unfolded orientation. When in the unfolded orientation, a user can hang portable storage tote 306 along a rail, wall, lift, etc. on a work site.

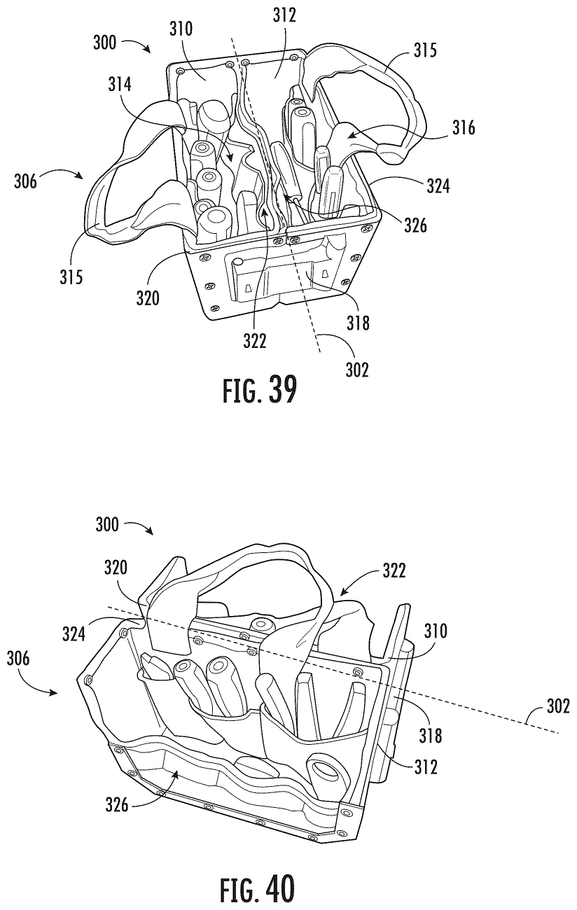

As shown in FIGS. 39-41, portable storage tote 306 is foldable into various orientations to adapt to specific working environments and user needs. Portable storage tote 306 includes a first storage section 310 that includes a storage compartment 314 positioned between a side wall 320 and an opposing side wall 322 that leaves storage compartment 314 partially open. In other words, side wall 320 includes a height greater than a height of the opposing side wall 322 such that compartment 314 is not entirely enclosed. In specific embodiments, the first storage compartment 314 is defined between side wall 320 and opposing side wall 322. In other words, side wall 320 has a first height and side wall 322 has a second height. In such an embodiment, the first height is greater than the second height. In various specific embodiments, side wall 320 and opposing side wall 322 are formed from fabric. As will be generally understood, the differences in side walls 320, 322 allow for varied levels of accessibility to stored tools or accessories.

Portable storage tote 306 further includes a second storage section 312 with a storage compartment 316 positioned between a side wall 324 and an opposing side wall 326 that leaves storage compartment 316 partially open. In other words, the second storage compartment 316 is defined between side wall 324 and opposing side wall 326. Side wall 324 includes a height greater than a height of the opposing side wall 326 such that compartment 316 is not entirely enclosed. In other words, side wall 324 has a third height and side wall 326 has a fourth height. In such an embodiment, the third height is greater than the fourth height.

First storage section 310 is connected to second storage section 312 by a hinge 318. First storage section 310 and second storage section 312 are rotatable about hinge 318 to transition between the various orientations. In a specific embodiment, portable storage tote 306 is configured to have three separate orientations. In various embodiments, portable storage tote 306 includes one or more handles 315 to allow for carrying. In a specific embodiment, portable storage tote 306 has handles 315 coupled to side walls 320, 324.

As shown in FIG. 39, in a first orientation of portable storage tote 306, first storage section 310 and second storage section 312 are aligned along a first axis 302. First axis 302 extends away from hinge 318. Side walls 320 and 324 are the outermost walls in such an orientation. When a user wants increased access to the items stored within portable storage tote 306, the user can move first storage section 310 away from second storage section 312 (i.e., in a direction away from first axis 302) to move into a second orientation.

As shown in FIG. 40, in a second orientation of portable storage tote 306, the first storage section 310 and second storage section 312 are again aligned along first axis 302. However, side walls 320 and 324 are positioned adjacent to each other while side walls 320, 322 form the outermost or exterior walls of portable storage tote 306. In the second orientation, tools or accessories stored within front pockets 340 are easily accessible to a user.

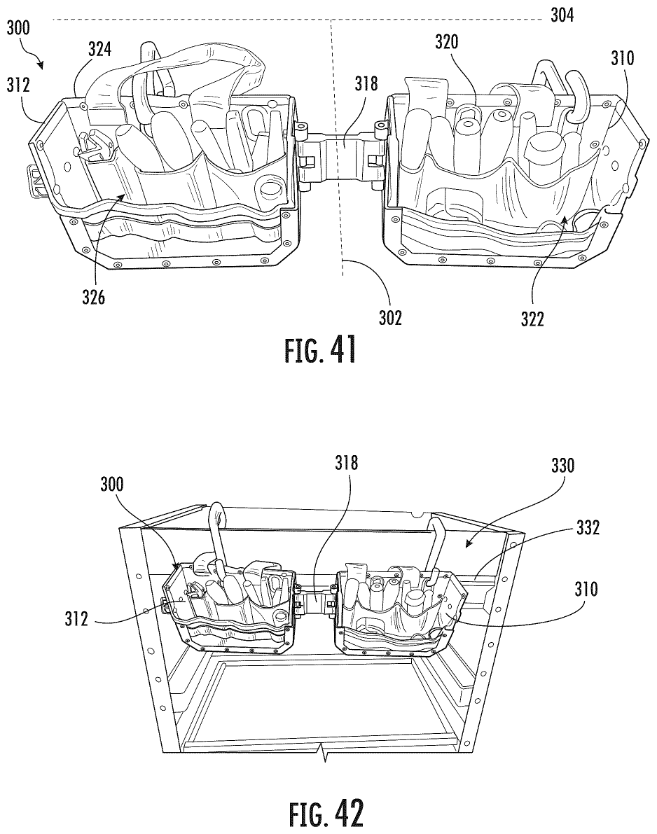

For working environments where quick access to all tools and accessories stored within portable storage tote 306, a user can move tote 306 into a third orientation. As shown in FIG. 41, first storage section 310 and second storage section 312 are not aligned with first axis 302. Instead, first storage section 310 and second storage 312 are in a linear orientation with hinge 318 open and extending between storage sections 310, 312. In specific embodiments, hinge 318 connects a rear surface of the first storage section 310 and a rear surface of the second storage section 312. In such an orientation, storage tote 306 is aligned along a second axis 304. In other words, in a linear orientation, a longitudinal axis of first storage section 310 and a longitudinal axis of second storage section 312 are colinear. In such an embodiment, the hinge 318 is in an open position and has an orientation aligned with the first side wall 320 and the third side wall 324. In other words, storage tote 306 is moveable between a first position in which the first storage section 310 and the second storage section 312 are closed, a second position in which the first storage section 310 and the second storage section 312 are open, and a third position in which the first storage section 310 and second storage section 312 have a linear orientation.

As previously discussed, first axis 302 extends outward from hinge 318. In contrast, second axis 304 extends along a longitudinal axis or length of hinge 318. In other words, second axis 304 extends in a generally perpendicular (e.g., 90 degrees plus or minus 10 degrees) orientation from first axis 302. In the third orientation, both lower side walls 326 and 326 face in the same direction (i.e., forward in the orientation shown in FIG. 41).

Referring to FIG. 42, when portable storage tote 306 is in the third orientation, portable storage tote 306 can be attached to a cart 330 and specifically a rail 332. Portable storage tote 306 can be hung along carts 330, walls, lifts, etc. in the working environment.

Referring to FIGS. 43-47, various aspects of portable storage tote 306 are shown according to exemplary embodiments. Referring to FIG. 43, a side view showing first storage section 310 from the outside is shown, according to an exemplary embodiment. As shown in FIG. 44, when portable storage tote 306 is oriented in an open position, front pockets 340 and back pockets 342 are visible. In specific embodiments, a first height of back pockets 342 is different than a second height of front pockets 340. In specific embodiments, back pockets 342 have a first height that is greater than a second height of front pockets 340. As shown in FIG. 47, when portable storage tote 306 is closed and viewed from above, back pockets 340 of first storage section 310 and second storage section 312 are adjacent to each other.

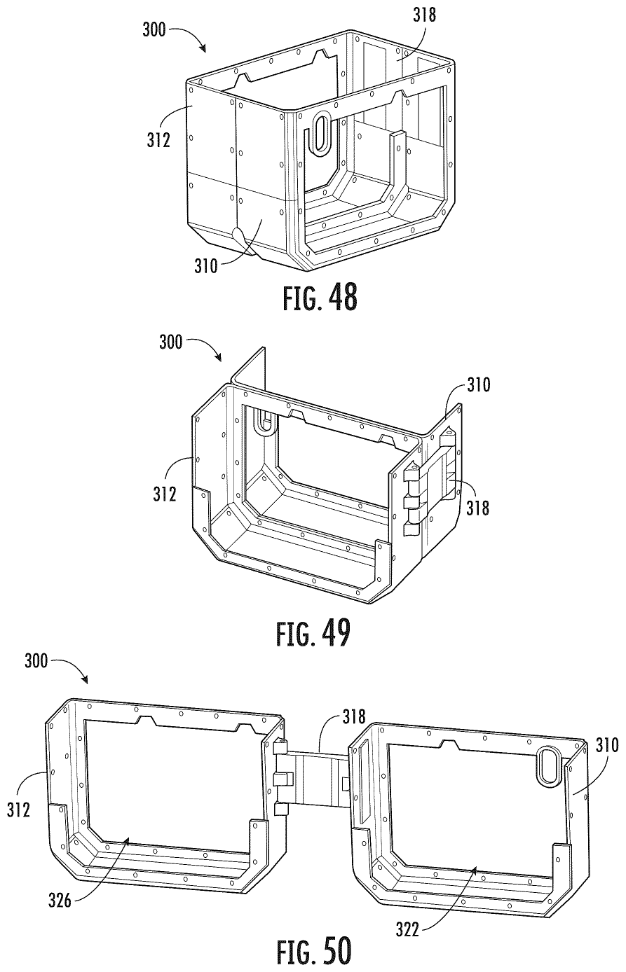

Referring to FIGS. 48-50, various aspects of portable storage tote 306 are shown according to an exemplary embodiment. In various specific embodiments, portable storage tote 306 includes a rigid structure or frame with flexible sides and pockets for storage. In other words, a flexible material defines the side walls and one or more pockets. In specific embodiments, the flexible sides and pockets are formed from fabric. FIGS. 48-50 only show the rigid structure of portable storage tote 306. FIG. 48 shows portable storage tote 306 in the first orientation. FIG. 49 shows portable storage tote 306 in the second orientation. FIG. 50 shows portable storage tote 306 in the third orientation.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A portable storage device comprising:
a first storage section comprising:
a first side wall having a first height;
a second side wall opposing the first side wall, the second side wall having a second height; and
a first storage compartment defined between the first side wall and the second side wall, wherein the first height is greater than the second height;
a second storage section coupled to the first storage section, the second storage section comprising:
a third side wall having a third height;
a fourth side wall opposing the third side wall, the fourth side wall having a fourth height; and
a second storage compartment defined between the third side wall and the fourth side wall, wherein the third height is greater than the fourth height; and
one or more couplers extending from a lower surface;
wherein the portable storage device is movable between a first position in which the first storage section and the second storage section are closed, a second position in which the first storage section the second storage section are open, and a third position in which first storage section and the second storage section have a linear orientation.

2. The portable storage device of claim 1, wherein, when the first storage section and the second storage section are in the third position, a first longitudinal axis of the first storage section is colinear with a second longitudinal axis of the second storage section.

3. The portable storage device of claim 1, wherein, when the first storage section and the second storage section are in the first position, the first side wall of the first storage section and the third side wall of the second storage section define outermost surfaces of the portable storage device.

4. The portable storage device of claim 1, wherein, when the first storage section and the second storage section are in the second position, the second side wall of the first storage section and the fourth side wall define the outermost surfaces of the portable storage device.

5. The portable storage device of claim 1, wherein the couplers are configured to engage one or more female couplers defined in an upper surface of another utility module.

6. The portable storage device of claim 1, further comprising:
a rigid frame; and
a flexible material that defines the first side wall, the second side wall, the third side wall, and the fourth side wall, wherein the flexible material defines one or more storage pockets.

7. The portable storage device of claim 1, wherein the second storage section is coupled to the first storage section by a hinge extending between and connecting a first rear surface of the first storage section and a second rear surface of the second storage section.

8. The portable storage device of claim 7, wherein, when the first storage section and the second storage section are in the third position, the hinge is in an open position and has an orientation aligned with the first side wall and the third side wall.

9. A utility module comprising:
a base defining a storage compartment;
a lid coupled to the base, the lid comprising:
an exterior surface;
one or more couplers defined in the exterior surface; and
an opposing interior surface, the interior surface comprising:
a plurality of ribs; and
one or more recessed sections defined between adjacent ribs of the plurality of ribs;
a mounting plate coupled to the interior surface of the lid, the mounting plate
a plurality of mounting holes extending through the mounting plate; comprising:
wherein the mounting plate is configured to support tools or accessories along the lid.

10. The utility module of claim 9, wherein the mounting plate has a first size and the interior surface of the lid has a second size, and wherein the first size is half of the second size.

11. The utility module of claim 9, further comprising a bracket coupled to the mounting plate, the bracket comprising an arm, the arm configured to secure a storage device along an interior surface of the mounting plate.

12. The utility module of claim 11, wherein, when the storage device is supported by the bracket, the storage device is positioned between the arm and the lid.

13. The utility module of claim 9, further comprising a magnetic plate coupled to the mounting plate, the magnetic plate configured to support a plurality of components along the lid.

14. The utility module of claim 13, wherein the plurality of components include fasteners, nails, or tool bits.

15. The utility module of claim 9, further comprising a pouch coupled to the mounting plate, wherein the pouch is formed from a fabric material.

16. A utility module comprising:
a base comprising:
an interior surface, the interior surface defining a storage compartment;
a lid coupled to the base, the lid comprising:
an exterior surface; and
one or more couplers defined in the exterior surface;
a cubby positioned within the storage compartment and along a side of the interior surface of the base, the cubby defining a second storage compartment configured to receive and support tools; and
one or more cartridges positioned within the storage compartment and coupled to the base, the one or more cartridges configured to interlock with other cartridges, the one or more cartridges each comprising an opening configured to receive and support a tool.

17. The utility module of claim 16, further comprising one or more wall panels mounted along the interior surface of the base, wherein the one or more wall panels are positioned between the base and the one or more cartridges.

18. The utility module of claim 17, where each of the one or more wall panels comprises:
a front wall; and
a compartment defined by the front wall.

19. The utility module of claim 16, wherein the one or more cartridges each comprise:
a body, the body comprising a dovetail joint; and
a top coupled to the body, wherein the opening is defined in the top.

20. The utility module of claim 19, further comprising one or more wall panels mounted along the interior surface of the base, the one or more wall panels comprising a second dovetail joint configured to receive and engage the dovetail joint of the one or more cartridges.
